(19) United States
(12) Patent Application Publication
(10) Pub. No.: US 2009/0171684 A1
(43) Pub. Date: Jul. 2, 2009

(54) ENHANCED ON-DEMAND DIAGNOSTIC AND MAINTENANCE REPORTING

(75) Inventors: Steven J. Samolinski, Rochester Hills, MI (US); Michael Maten, Troy, MI (US); John J. Correia, Livonia, MI (US); Kelley J. Kettenbeil, Milford, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GENERAL MOTORS CORPORATION, Detroit, MI (US)

(21) Appl. No.: 11/967,347

(22) Filed: Dec. 31, 2007

(51) Int. Cl. G01M 17/00; G06Q 99/00; H04M 3/42

(52) U.S. Cl. 705/1; 701/33; 455/414.1

(57) ABSTRACT

A system and method for providing enhanced diagnostic and maintenance reporting for a vehicle over a wireless communication system. When receiving a telephone call from a subscriber requesting diagnostic assistance, a data connection is established between a call center and the subscriber's vehicle, and the needed diagnostic data is obtained by the call center so that an advisor at the call center can provide the requested assistance. The established data connection is also used to obtain additional data from the vehicle related to vehicle maintenance and this additional data is used by the advisor to provide an enhanced response to the subscriber.

### TECHNICAL FIELD

The present invention relates generally to vehicle telematics services and, more particularly, to systems and methods for providing subscribers of vehicle telematics services with diagnostic and maintenance information for their vehicle.

### BACKGROUND

Telematics units are now routinely incorporated into vehicles as OEM installed components that enable wireless communication to and from the vehicle. This communication includes voice telephone calls as well as data communication of diagnostic and maintenance information from the vehicle. The telematics units are most often used in conjunction with a vehicle telematics service that is provided by the vehicle manufacturer or third party service provider. These telematics services allow the subscriber to connect to a call center operated by the telematics service provider and request assistance and other services.

One such service in use today is “on-demand” diagnostic assistance which allows the subscriber to call into the call center from the vehicle via the telematics unit and request assistance with a diagnostic problem he or she is experiencing in the vehicle. Typically, this request is handled by a live (human) advisor at the call center who has the ability via the call center communications system to obtain diagnostic data from the vehicle during the telephone call and use that data to provide the subscriber with the requested assistance. This involves making a data connection between the call center and vehicle telematics unit to obtain the needed diagnostic data.

Apart from responding to on-demand requests from a subscriber, telematics service providers also provide other types of services such as emergency notification in the event of an airbag deployment, navigation assistance, remote door unlocking, and maintenance reporting services. One type of maintenance reporting service involves periodically obtaining vehicle maintenance information from the vehicle and sending that information to the associated subscriber electronically, such as via email. One difficulty with obtaining data periodically from the vehicle is that it may not be available at the desired time (e.g., the vehicle may be off and the telematics unit powered down). For this purpose, maintenance reporting is often carried out by setting a trigger in the vehicle so that the vehicle then initiates the data upload to the call center at a time when the vehicle is available. This can provide a more robust means of establishing a connection between the vehicle and call center than if the call center were to initiate the connection.

### SUMMARY OF THE INVENTION

The present invention can be used to provide the telematics service subscriber with improved service and/or to help overcome the occasional difficulty in connecting with the vehicle to obtain maintenance information. This is done by leveraging the data connection that is established when the subscriber calls to request diagnostic assistance so that maintenance-related data can also be obtained at the same time.

Thus, according to one aspect of the invention, there is provided a method of providing enhanced diagnostic and maintenance reporting for a vehicle over a wireless communications system. The method is used in connection with a vehicle having a telematics unit installed on the vehicle that communicates electronically with various vehicle system modules to receive vehicle data from the vehicle system modules. The method includes the steps of:
receiving a telephone call from a caller requesting vehicle operational condition assistance, wherein the telephone call includes at least a portion of the call in which the caller speaks with an advisor at a call center;
retrieving operational condition data that includes diagnostic data associated with the caller's request, wherein the retrieval of operational condition data includes sending the diagnostic data from the vehicle to a central facility via the telematics unit;
retrieving additional data relating to vehicle maintenance by sending the additional data from the vehicle to the central facility via the telematics unit;
providing a verbal response to the caller over the telephone call based on the retrieved diagnostic data; and
providing additional maintenance information to the caller based on the retrieved additional data.

In accordance with another aspect of the invention, there is provided a system for providing enhanced diagnostic and maintenance reporting for a vehicle. The system includes a call center, wireless carrier system, and vehicle equipped with a telematics unit that includes wireless telephony components that communicate with the call center via the wireless carrier system. The call center receives telephone calls from telematics services subscribers and has access to data received from callers' vehicles via the telematics unit. This data can be obtained by the telematics unit from various vehicle system modules that communicate electronically with the telematics unit. The call center includes at least one computer that responds to requests from an advisor at the call center and obtains operational condition data from the vehicle that includes both diagnostic data associated with a caller's request and additional data relating to vehicle maintenance. The call center is configured such that, during a telephone call between a caller and the advisor, the telephone call is switched from a voice mode to a data mode, the at least one computer obtains the operational condition data, the telephone call is switched back to the voice mode and transferred to a second, different advisor, and the diagnostic data and additional data are both supplied to the second advisor. Then, the second advisor can provide diagnostic assistance and maintenance information to the caller during the telephone call.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein; and

FIG. 2 is a flow chart of one embodiment of a method in accordance with the invention that can be carried out using the communications system of FIG. 1; and

FIG. 3 is a flow chart of one particular implementation of the method of FIG. 1.

### DETAILED DESCRIPTION OF THE PREFERRED EMBODIMENT(S)

The system and method described below enable advisors at a call center to provide enhanced reporting to a caller of the diagnostic and maintenance status of the caller's vehicle. Thus, when a subscriber or other caller initiates a call to the call center to request assistance concerning a vehicle operational condition, the data needed to assist the caller can be obtained from the vehicle and the advisor's response can be enhanced by using the data connection to the vehicle to also obtain additional data relating to vehicle maintenance, such as mileage or remaining oil life. This additional data can be used by the advisor to report information to the caller concerning upcoming maintenance issues, and that reporting can be done either verbally during the call and/or can be sent electronically such as by email for subsequent access and review by the caller.

As used herein, “subscriber” can be the vehicle owner, lessee, or other person authorized to obtain information concerning the operational condition of the vehicle. “Operational condition” refers to the state of the vehicle or of individual components or modules of the vehicle and can include diagnostic status (represented by diagnostic trouble codes or other information that can be retrieved from the vehicle) as well as maintenance-related data (including odometer reading, oil life, tire pressure, etc.). The diagnostic data and maintenance-related data need not be exclusive of each other; for example, tire pressure can be used both for diagnostic purposes, such as to explain why a warning light on the dashboard is illuminated or to determine why vehicle fuel efficiency (mpg) has dropped, and for maintenance purposes such as to recommend that tire pressure be checked.

### Communications System

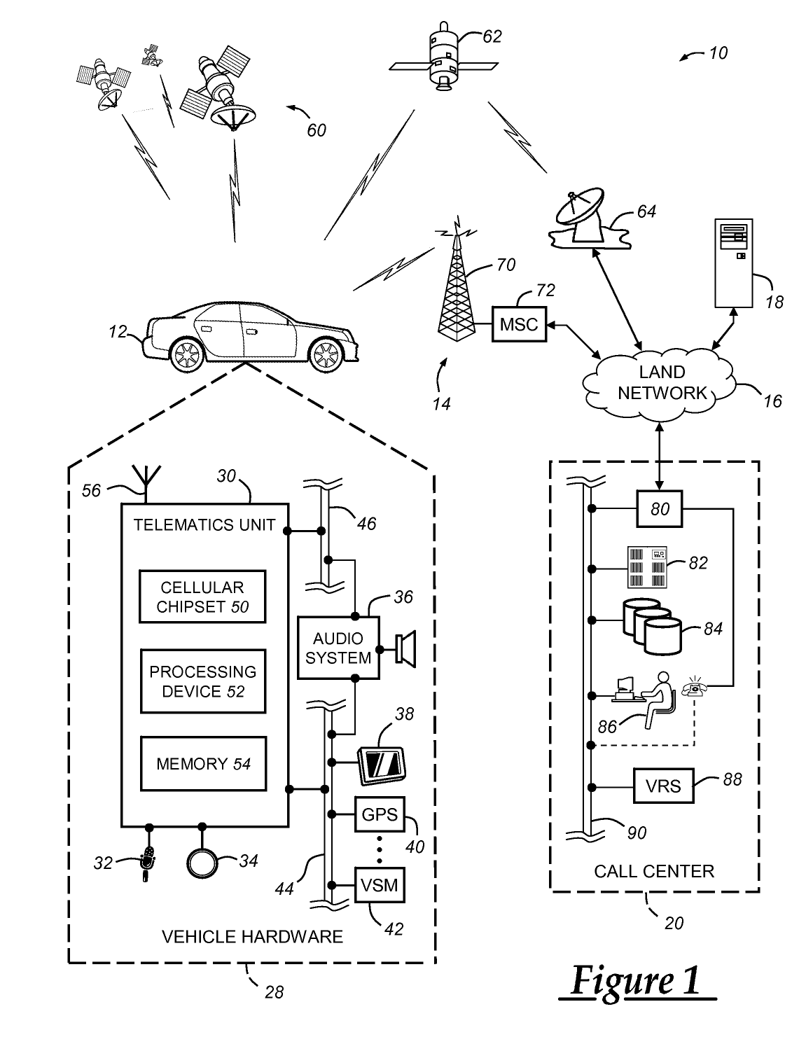

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is an OEM-installed device that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes wireless telephony components including a standard cellular chipset 50 for voice communications like hands-free calling and a wireless modem for data transmission. The telematics unit also includes an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wireless according to one or more wireless protocols, such as any of the IEEE 802.11 protocols, WiMAX, or Bluetooth. When used for packet-switch data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

For purposes of providing diagnostic support from an advisor 86, 88 at the call center 20, vehicle data, such as diagnostic data and maintenance-related data such as DTCs, mileage, oil life, tire pressure, etc., can be sent directly from the telematics unit 30 to the call center 20, and this can be done in response to an initiating request from an advisor at the call center. The transmission of this data can be done in any of the various ways noted above. Thus, for example, where a subscriber places a telephone call to the call center 20 via the telematics unit 30 and requests assistance with a diagnostic issue, the advisor can request vehicle data which is retrieved electronically from the telematics unit during the telephone call. This can be done by switching the telephone call from a voice mode to a data mode, which enables the call center and telematics unit to establish a data connection and upload the desired information to the call center while the subscriber waits on hold. Once the data is transferred, the call can be switched back to voice mode to resume the conversation with the subscriber. Techniques for carrying out this switching between voice and data modes is known to those skilled in the art. Additionally, instead of sending the diagnostic and other vehicle data directly from telematics unit 30 to the call center 20, it will be appreciated that such data can be sent from the telematics unit 30 to a different central facility, such as computer 18 or some other location that may be remote from the call center 20. Then, for purposes of data storage or diagnostic assistance by an advisor 86, 88, the vehicle data can be sent from the other central facility to the call center 20.

### Enhanced Diagnostic and Maintenance Reporting Method

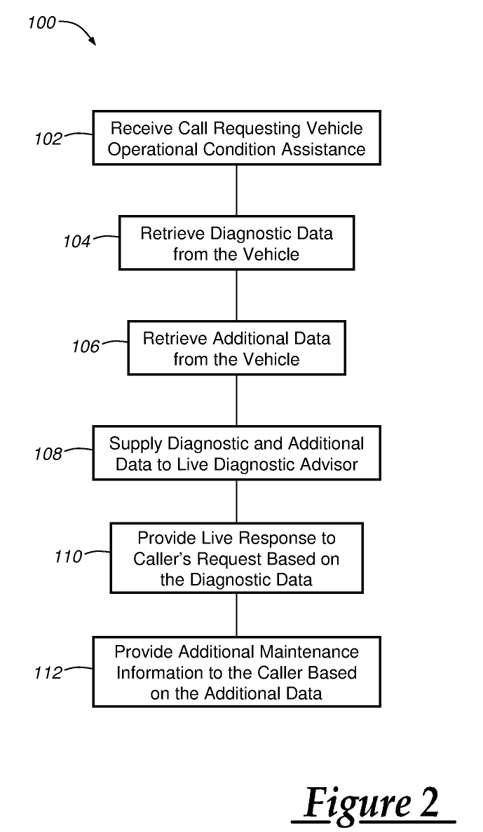

Turning now to FIG. 2, there is shown a flow chart of a method 100 for providing enhanced diagnostic and maintenance reporting. This method can be carried out by a telematics service provider using its call center to not only respond to a subscriber request for diagnostic assistance, but to provide enhanced reporting and, thus improve the customer experience with the telematics service provider. The general method provided in FIG. 2 can be implemented in various ways as will become apparent to those skilled in the art.

The process begins at step 102 where a telephone call is received at the call center 20 requesting vehicle operational condition assistance. This can be, for example, a call initiated by the subscriber from their vehicle 12 via its telematics unit 30. Alternatively, it can be a call received from a voice communication device other than the telematics unit 30. As used herein, “voice communication device” refers to a device capable of placing voice telephone calls including wired (landline) telephones, mobile telephones either as standalone cell phones or as PDAs, etc. The subscriber's request for vehicle operational condition assistance can be, for example, a verbal request for diagnostic assistance such as “Why is my check engine light on?” This request is handled by an advisor at the call center 20, and the advisor can be the live advisor 86 or the VRS 88.

Then, at step 104, operational condition data is retrieved electronically from the vehicle 12 using the telematics unit 30. In this step, the operational condition data retrieved is that diagnostic data believed necessary or potentially useful in rendering the requested assistance to the subscriber. This retrieval can be initiated by the advisor at the call center 20 either as a general request for all diagnostic data or as a specific request for particular data such as, for example, emission control DTCs. At step 106, additional data related to vehicle maintenance is also retrieved. This additional data can include, for example, mileage, oil life, and tire pressure, and it will be appreciated that this data can be retrieved before, after, or simultaneously with the retrieved diagnostic data. That is, steps 104 and 106 can be carried out in any order or together, and are preferably carried out using the same data connection.

As one example, the retrieval of operational condition data that includes both the diagnostic data and maintenance-related (additional) data can be carried out as follows. At the initiation of the advisor at the call center 20, a data connection is established between the vehicle and a central facility. As noted earlier above, the central facility can be the call center 20 itself or another remotely located facility such as the computer 18.

A request for the operational condition data is sent to the vehicle over this data connection. The telematics unit 30 receives this request and obtains from the various vehicle system modules (VSMs) the needed data. That data is then transmitted by the telematics unit to the central facility over the data connection.

Establishment of the data connection can be carried out in any of the various ways discussed above. For example, where the telephone call from the subscriber is by way of the vehicle telematics unit 30, the data connection can be established by having the subscriber wait (on hold), switching the telephone call from a voice mode to a data mode (i.e., switched from a mode in which speech is transmitted over the call to a mode in which data is transmitted over the call). The data can then be transmitted while the subscriber briefly waits. Placing the caller on “hold” does not necessarily require any particular technical or electronic process, but means that the caller cannot carry out voice communication on the call while in the data mode. As will be appreciated by those skilled in the art, this data mode approach involves transmitting the data from the vehicle over a voice channel of the wireless carrier system, and techniques for doing so are known and in use today. Once the data is uploaded to the call center, the call is switched from the data mode back to the voice mode so that the conversation with the subscriber can be resumed. Alternatively, where the subscriber's call is not placed via the telematics unit, or where another data communication path is available and desired, the operational condition can be retrieved via a data connection that is separate from the telephone call.

Then, at step 108, the retrieved diagnostic and additional data is supplied to a live diagnostic advisor 86 at the call center. This live advisor can be the same advisor that initially received the call or can be a different advisor, but in either case preferably is someone trained to handle diagnostic assessments so that they can provide a meaningful response to the subscriber's request. Where the diagnostic and additional data was uploaded from the vehicle directly to the call center 20, this step 108 can be carried out by routing the data within the call center to the advisor's computer or supplying it to a diagnostic tool in the form of software used by the advisor on his or her computer. In FIG. 1, this diagnostic tool is represented by the computer shown in conjunction with advisor 86, although it will be appreciated that the diagnostic tool could be implemented as server software on one of the servers 82. As one example, the diagnostic tool utilizes DTCs to provide the advisor with a description of what the DTC means and what remedial action can be taken. Such tools are known to those skilled in the art and are in use today. Where the call center is not used as the central facility for uploading of the data, the retrieved data can first be transferred to the call center and then provided to the advisor in responding to the subscriber's request.

At step 110, using the diagnostic data, the diagnostic advisor 86 provides a live response to the subscriber's request, and this is preferably provided verbally to the caller over the ongoing telephone call. For the example query given above, “Why is my check engine light on?”, using the diagnostic data the live advisor may be able to advise the subscriber of the reason for the warning light having been triggered and may be able to provide the subscriber with instructions as to how the situation can be remedied.

Apart from answering the subscriber's specific query, the additional data received by the advisor from the vehicle can be used to provide additional maintenance information to the subscriber, such as a recommendation to have tire pressure checked or to have the tires rotated or to schedule an oil change. This is shown at step 112. Providing this information to the subscriber can help improve customer satisfaction with the telematics services provider. It can also help avoid missed maintenance events and, using the disclosed method, is done so in a manner that helps minimize the additional costs in terms of data and telematics services resources. In supplying the additional maintenance information to the subscriber, the advisor can either provide that information verbally during the telephone call, or can supply the information electronically for subsequent presentation to the subscriber after the telephone call is terminated. In this latter case, an email address for the subscriber can be obtained and used to send an email that provides the maintenance information. The email address can be obtained during the telephone call from the subscriber or accessed from a database of subscriber information.

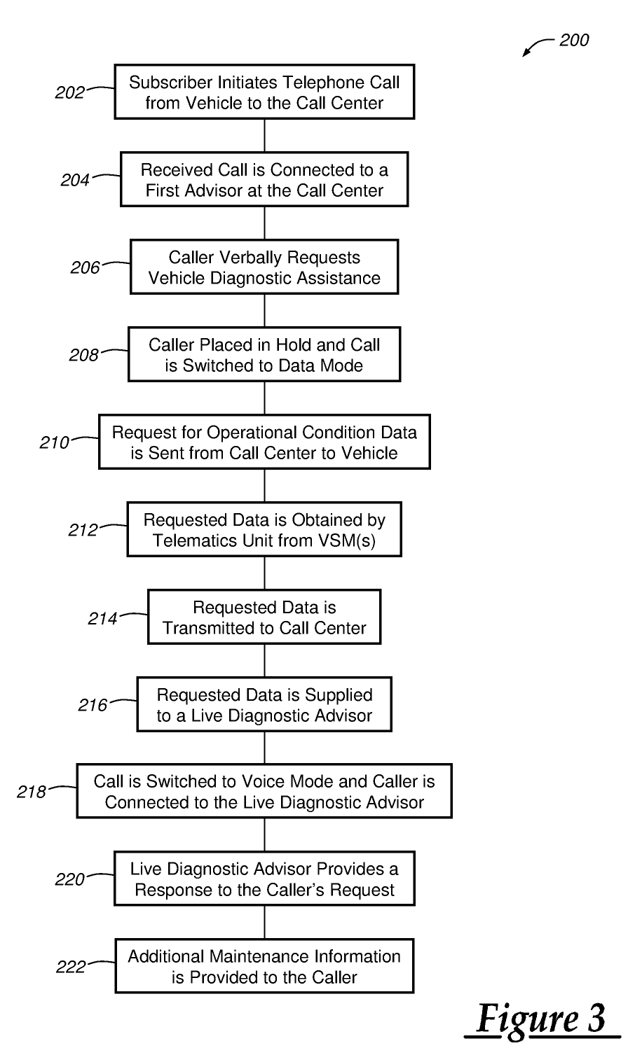

Referring now to FIG. 3, there is shown one particular implementation 200 of the method of FIG. 2. The method 200 starts at block 202 where the subscriber initiates a telephone call to the call center. The received call is connected to a first advisor at the call center, step 204. Then, the caller verbally requests vehicle diagnostic assistance (e.g., “Why is my check engine light on?” or “Why is my engine running rough?”), step 206. The caller is then asked to wait while the needed diagnostic data is retrieved and so is placed on hold and the call is switched to the data mode, step 208. Then, at step 210 a request is sent from the call center to the vehicle for operational condition data, including both diagnostic data and additional data relating to vehicle maintenance. The requested data is obtained by the telematics unit from one or more of the VSMs, step 212. Then, at step 214, that requested data is transmitted by the telematics unit to the call center, and the data received at the call center is then supplied to a live diagnostic advisor, step 216. The call is then switched back to voice mode and the caller is connected to the live diagnostic advisor, step 218. Then, at step 220, the diagnostic advisor provides a response to the caller's request using the obtained diagnostic data. Finally, additional maintenance information is provided to the caller, step 222. As noted above, this additional maintenance information can be supplied to the caller verbally during the call or can be transmitted electronically for subsequent access and review by the caller. The method then ends.

This process can be used to permit initial call handling and screening by a first advisor that need not be specially trained in vehicle diagnosis, with the first advisor then being freed up to handle other calls once the switch to data mode is carried out, and the call then being transferred to a second, diagnostic advisor who does have such specialized training and who can assist the caller using the diagnostic data uploaded to the call center. In this regard, the process permits the use of an automated advisor such as VRS 88 as the first advisor, in lieu of a live advisor, to initially handle the call.

As will be appreciated by those skilled in the art, these methods can be carried out using the system of FIG. 1 with the necessary programming at the call center being used to carry out the automated parts of the method. Thus, the call center will include at least one computer that responds to requests from an advisor at the call center and that obtains the operational condition data from the vehicle. Furthermore, the call center can be configured to switch the ongoing telephone call from the voice mode to the data mode, so that the call center computer can then obtain the operational condition data. The call center will then automatically switch the telephone back to the voice mode and transfer it to the live diagnostic advisor, and will also supply the diagnostic data and additional data to that same diagnostic advisor so that he or she can provide diagnostic assistance and maintenance information to the caller during the telephone call.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, various steps of the methods described above can be carried out in an order that is different than shown. For example, the telematics unit need not obtain any or all of the vehicle operational condition data after receiving a request for it from the call center. Rather, the requested data can be pre-stored as a part of a regular on-board diagnostic reporting and storage process. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of providing enhanced diagnostic and maintenance reporting for a vehicle over a wireless communications system, wherein the vehicle includes a telematics unit installed on the vehicle that communicates electronically with various vehicle system modules to receive vehicle data from the vehicle system modules, the method comprising the steps of:
receiving a telephone call from a caller requesting vehicle operational condition assistance, wherein the telephone call includes at least a portion of the call in which the caller speaks with an advisor at a call center;
retrieving operational condition data that includes diagnostic data associated with the caller's request, wherein the retrieval of operational condition data includes sending the diagnostic data from the vehicle to a central facility via the telematics unit;
retrieving additional data relating to vehicle maintenance by sending the additional data from the vehicle to the central facility via the telematics unit;
providing a verbal response to the caller over the telephone call based on the retrieved diagnostic data; and
providing additional maintenance information to the caller based on the retrieved additional data.

2. The method of claim 1, further comprising the step of the caller initiating the telephone call from the vehicle via the telematics unit.

3. The method of claim 2, wherein the steps of retrieving operational condition data and retrieving additional data together further comprise the steps of switching the telephone call from a voice mode to a data mode, retrieving the diagnostic data and additional data while in the data mode, and then switching the telephone call from the data mode back to the voice mode.

4. The method of claim 3, wherein, prior to switching to the data mode, the caller speaks with a first advisor and wherein, after switching from the data mode back to the voice mode the caller speaks with a different, second advisor who is a live diagnostic advisor.

5. The method of claim 4, wherein the first advisor is a live advisor.

6. The method of claim 4, further comprising the step of providing the diagnostic data to a diagnostic tool operated by the live diagnostic advisor.

7. The method of claim 1, further comprising the step of the caller initiating the telephone call via a voice communication device other than the telematics unit, wherein the operational condition data is retrieved via a communication that is separate from the telephone call.

8. The method of claim 1, wherein central facility is the call center.

9. The method of claim 1, wherein the retrieving step further comprises providing the diagnostic data from one or more of the vehicle system modules to the telematics unit for subsequent transmission to the central facility.

10. The method of claim 1, wherein the step of providing additional maintenance information further comprises providing the additional maintenance information verbally to the caller over the telephone call.

11. The method of claim 1, wherein the step of providing additional maintenance information further comprises providing the additional maintenance informnation electronically for access by the caller at a time after the telephone call is terminated.

12. The method of claim 11, wherein the step of providing the additional maintenance information electronically further comprises the steps of obtaining an email address for the caller and sending the additional maintenance information to the caller via email.

13. A method of providing enhanced diagnostic and maintenance reporting for a vehicle over a wireless communications system, wherein the vehicle includes a telematics unit installed on the vehicle that communicates electronically with various vehicle system modules to receive vehicle data from the vehicle system modules, the method comprising the steps of:
initiating a telephone call from a caller via the vehicle telematics unit to a call center;
connecting the telephone call to a first advisor at the call center;
receiving a verbal request from the caller for vehicle operational condition assistance;
retrieving operational condition data during the telephone call, wherein the step of retrieving operational condition data further comprises the steps of:
sending a request over the telephone call from the call center to the vehicle telematics unit requesting diagnostic data and additional data relating to vehicle maintenance;
obtaining the requested data at the telematics unit from one or more vehicle system modules located on the vehicle; and
transmitting the requested data to the call center over the telephone call;
connecting the caller to a second, different advisor that is a live diagnostic advisor;
supplying the requested data to the live diagnostic advisor;
providing a verbal response from the live diagnostic advisor to the caller over the telephone call based on the diagnostic data; and
providing additional maintenance information to the caller based on the additional data.

14. A system for providing enhanced diagnostic and maintenance reporting for a vehicle over a wireless communications system, comprising:
a call center that receives telephone calls from telematics services subscribers and that has access to data received from callers' vehicles;
a wireless carrier system that enables wireless telephone calls between callers and the call center;
a vehicle equipped with a telematics unit that communicates electronically with various vehicle system modules to receive vehicle data from the vehicle system modules, the telematics unit including wireless telephony components that communicate with the call center via the wireless carrier system;
wherein the call center includes at least one computer that responds to requests from an advisor at the call center and obtains operational condition data from the vehicle that includes both diagnostic data associated with a caller's request and additional data relating to vehicle maintenance; and
wherein the call center is configured such that, during a telephone call between a caller and the advisor, the telephone call is switched from a voice mode to a data mode, the at least one computer obtains the operational condition data, the telephone call is switched back to the voice mode and transferred to a second, different advisor, and the diagnostic data and additional data are both supplied to the second advisor, wherein the second advisor can provide diagnostic assistance and maintenance information to the caller during the telephone call.

15. A system as defined in claim 14, wherein said wireless telephony components include a cellular chipset, data modem, or both.

16. A system as defined in claim 14, wherein the call center includes a voice response unit that operates as an advisor.

17. A system as defined in claim 14, wherein the diagnostic data includes one or more diagnostic trouble codes and wherein the call center includes a diagnostic tool comprising a programmed computer that receives the one or more diagnostic trouble codes and provides the second advisor with information based on the one or more diagnostic trouble codes.
